(19) United States
(12) Patent Application Publication
(10) Pub. No.: US 2026/0063355 A1
(43) Pub. Date: Mar. 5, 2026

(54) REFRIGERATOR

(71) Applicant: LG Electronics Inc., Seoul (KR)

(72) Inventors: Seungjin LEE, Seoul (KR); Ahreum PARK, Seoul (KR); Yoojin JUNG, Seoul (KR); Honggu LIM, Seoul (KR)

(21) Appl. No.: 19/364,433

(22) Filed: Oct. 21, 2025

(30) Foreign Application Priority Data
Aug. 30, 2024 (KR) 10-2024-0118034
Jan. 10, 2025 (KR) 10-2025-0004251

(51) Int. Cl. F25D 23/06; B01D 53/04

(52) U.S. Cl. CPC F25D 23/062; B01D 53/0446; B01D 2257/90; B01D 2259/45

(57) ABSTRACT

Provided is a refrigerator including a case having a storage space with one side open, a door arranged on the case to open and close the storage space, a shelf installed inside the case in the storage space, at least two shafts installed at the shelf to be spaced apart from each other, and a filter module including a filter member and detachably installed on the shafts.

### CROSS-REFERENCE TO RELATED APPLICATIONS

Pursuant to 35 U.S.C. § 119 (a), this application claims the benefit of the earlier filing date and the right of priority to Korean Patent Application Nos. 10-2024-0118034, filed on Aug. 30, 2024, and 10-2025-0004251, filed on Jan. 10, 2025, the contents of which are incorporated by reference herein in their entirety.

### TECHNICAL FIELD

The disclosure relates to a refrigerator, and more particularly, to a refrigerator in which a deodorizer for absorbing odors inside the refrigerator can be installed.

### BACKGROUND

Generally, a refrigerator is a home appliance which allows food to be stored at low temperature in an inner storage space which is shielded by a refrigerator door. To this end, it is configured to keep the stored food in an optimal condition by cooling the inside of the storage space using cold air, which is generated through heat exchange with refrigerant circulating in a refrigeration cycle.

In a refrigerator, refrigerant compressed by a compressor circulates along an evaporator, and absorbs heat from surrounding air during evaporation in the evaporator, which lowers temperature. This process is repeatedly performed and simultaneously a blower fan arranged on a rear surface of a freezing chamber and/or a refrigerating chamber is driven to discharge the cold air.

Therefore, cold air keeps food frozen in a freezing chamber or fresh at a low temperature in a refrigerating chamber, to suppress spoilage and loss of freshness. This enables a variety of foods to be stored for a long time.

Unlike a freezing chamber where food is stored in a frozen state, a refrigerating chamber stores food at a temperature above a freezing point and stores cooked food or food with a distinctive strong odor for a long period of time due to its usage conditions. As a result, odors generated during food storage may cause discomfort to the user.

In line with the trend of changing eating habits and the advancement of product premiumization, refrigerators are becoming larger and more multifunctional, and refrigerators equipped with various structures and convenient devices which take user convenience into consideration are being released.

In particular, there are refrigerators equipped with deodorizing devices to improve the hygiene inside the refrigerators and to resolve user complaints about bad odors.

Patent Document 1 discloses a structure in which a plurality of guide rods are installed horizontally below a shelf, and a rivet pin structure and a deodorizing filter are lifted to be fitted onto the guide rods.

In particular, a switching slope is provided to switch forward and backward movement caused by the rotation of a lever into up and down movement of a door.

There is a problem that the guide rods could not be used when hook rivets for holding the guide rods are destroyed due to the fatigue life thereof.

Therefore, it is necessary to develop a structure which can utilize existing shaft guides below a shelf and easily attach a deodorizing filter without any special tools.

### PRIOR ART DOCUMENT

### Patent Document

Published Utility Model Publication No. 86-8295 (Jul. 24, 1986)

### SUMMARY

The disclosure has been devised to solve the above problems, and a first aspect of the disclosure is to provide a refrigerator with a structure including a deodorizing filter for absorbing and reducing food odors inside the refrigerator.

A second aspect of the disclosure is to provide a refrigerator with a deodorizing filter which can utilize an existing shelf structure by utilizing guides below a shelf already existing in the refrigerator.

A third aspect of the disclosure is to provide a refrigerator with a filter module having a structure which allows a user to easily install, replace, and remove a deodorizing filter module without additional tools or components.

According to achieve those aspects and other advantages, there is provided a refrigerator including a case having a storage space with one side open, a door arranged on the case to open and close the storage space, a shelf installed inside the case in the storage space, at least two shafts installed at the shelf to be spaced apart from each other, and a filter module including a filter member and detachably installed on the shafts.

Accordingly, an existing shelf structure can be used and the filter member can be installed by utilizing the shaft arranged below the shelf inside the refrigerator. This can result in absorbing and reducing food odors inside the refrigerator.

The filter module may include a coupling housing detachably installed on the shafts, a receiving housing installed on the coupling housing and having an accommodating space for accommodating the filter member, and the filter member installed in the accommodating space.

By coupling the coupling housing and the receiving housing, the filter module can be installed on the shafts, allowing the user to easily install, replace, and remove the deodorizing filter module without additional tools or components.

The receiving housing may be installed to be slidable relative to the coupling housing.

The receiving housing may include mounting portions formed by bending outward at ends of both side walls forming the accommodation space, and the coupling housing may include guide ribs arranged on both side walls thereof to support lower sides of the mounting portions, and connecting the mounting portions to be slidable.

The guide ribs may be formed by bending inward at ends of the both side walls of the coupling housing.

In this way, the receiving housing may include mounting portions, and the coupling housing may include guide ribs, such that the receiving housing can be slidable relative to the coupling housing. Therefore, the user can easily attach or detach the receiving housing to or from the coupling housing.

The receiving housing may include a pressing portion arranged on an outside thereof to be pressed by a user, and a stopping protrusion connected to the pressing portion and protruding from one side opposite to the pressing portion, and the coupling housing may include a protrusion rib fixed by catching the stopping protrusion in a state where the receiving housing has been inserted.

In this way, the receiving housing includes the pressing portion and the stopping protrusion, and the coupling housing may include the protrusion rib, such that the receiving housing can be attached to or detached from the coupling housing.

The coupling housing may include a first slot arranged on one side thereof and formed in a first direction to be guided and mounted on one of the at least two shafts, and a second slot arranged on the other side spaced from the one side, and formed in a second direction crossing the first direction, such that the filter module is secondarily coupled after being primarily mounted in the first slot.

Accordingly, the coupling housing can be stably and easily coupled to the front shaft and the rear shaft.

Preferably, the second slot may include an anti-separation portion protruding from an end portion thereof in the first direction by a predetermined distance to suppress separation of the other shaft.

The receiving housing may include side walls supporting the filter member on both sides thereof forming the accommodation space, and support portions having at least a portion bent or curved to support the filter member on the other side.

The refrigerator may further include a tray installed on the shafts to be movable along an extension direction of the shafts, and the filter module may be arranged on one side or the other side of the tray.

The coupling housing may include a coupling member protruding from one side thereof to detachably couple the coupling housing while surrounding a portion of the shaft, such that the filter module is arranged in a direction crossing the shelf.

Accordingly, the filter module can be stably coupled in a direction crossing a direction of the shelf.

The filter module may be arranged parallel to an inner wall of the case near the inner wall of the case.

The filter module may be arranged to be spaced apart from the shelf by a predetermined distance and parallel to the shelf.

The coupling housing may include a first flow path arranged spaced apart from the shelf by a predetermined distance, such that cold air flows between the coupling housing and the shelf.

Preferably, the coupling housing and receiving housing may each include a cold air passage hole through which cold air flows.

The cold air passage hole may be arranged as a plurality of cold air passage holes spaced apart from one another.

The coupling housing and receiving housing may each include a cold air passage hole through which cold air flows, and the refrigerator may further include second flow path through which cold air is introduced into the accommodation space or discharged from the accommodation space.

The refrigerator may further include a third flow path arranged below the receiving housing and communicating with the second flow path.

In this way, as the first to third flow paths can be formed inside or near the filter module, food odors inside the refrigerator can be more efficiently absorbed and reduced.

To solve another aspect of the disclosure, a refrigerator includes a case having a storage space with one side open, a door arranged on the case to open and close the storage space, a shelf installed inside the case in the storage space and including a food support plate, at least two shafts installed on the shelf to be spaced apart from each other, and a filter module including a filter member, and the filter module includes a coupling housing detachably installed on the shafts, spaced apart from the food support plate by a predetermined distance, and arranged parallel to the food support plate, a receiving housing installed on the coupling housing and having an accommodating space for accommodating the filter member, and the filter member installed in the accommodating space.

In this way, by coupling the coupling housing and the receiving housing, the filter module can be installed on the shafts, allowing the user to easily install, replace, and remove the deodorizing filter module without additional tools or components. The coupling housing can be positioned to be spaced apart from the food support plate of the shelf, thereby forming the first flow path.

The receiving housing may include mounting portions formed by bending outward at ends of both side walls forming the accommodation space, and the coupling housing may include guide ribs arranged on both side walls thereof to support lower sides of the mounting portions, and connecting the mounting portions to be slidable.

The guide ribs may be formed by bending inward at ends of the both side walls of the coupling housing.

In this way, the receiving housing may include mounting portions, and the coupling housing may include guide ribs, such that the receiving housing can be slidable relative to the coupling housing. Therefore, the user can easily attach or detach the receiving housing to or from the coupling housing.

The receiving housing may include a pressing portion arranged on an outside thereof to be pressed by a user, and a stopping protrusion connected to the pressing portion and protruding from one side opposite to the pressing portion, and the coupling housing may include a protrusion rib fixed by catching the stopping protrusion in a state where the receiving housing has been inserted.

The coupling housing may include a first slot arranged on one side thereof and formed in a first direction to be guided and mounted on one of the at least two shafts, and a second slot arranged on another side spaced from the one side, and formed in a second direction crossing the first direction, such that the filter module is secondarily coupled after being primarily mounted in the first slot.

The second slot may include an anti-separation portion protruding from an end portion thereof in the first direction by a predetermined distance to suppress separation of the other shaft.

The receiving housing may include side walls supporting the filter member on both sides thereof forming the accommodation space, and support portions having at least a portion bent or curved to support the filter member on the other side.

To solve another aspect of the disclosure, a refrigerator includes a case having a storage space with one side open, a door arranged on the case to open and close the storage space, a shelf installed inside the case in the storage space, a shaft installed on the shelf, and a filter module including a filter member installed in the accommodation space, and the filter module is installed detachably by including a coupling member having a curved shape to surround a portion of the shaft.

The case may include a cold air discharge port through which cold air is supplied to the storage space, and the filter module may be arranged to at least partially overlap the cold air discharge port.

The shaft may be positioned on the rear of the shelf to be arranged near a rear wall of the case, the coupling member may be arranged as two coupling members spaced apart from each other, and the two coupling members may be coupled to the shaft.

The filter module may include an accommodating housing including the coupling member and having the accommodation space therein, a cover housing coupled to the accommodating housing, and the filter member.

The cover housing may include a first coupling protrusion protruding from one side of the cover housing, and a second coupling protrusion protruding from the other side opposite to the one side, and the accommodating housing may include a first coupling hole formed in one side wall of the accommodating housing, such that the first coupling protrusion is inserted, and a second coupling hole formed in the other side wall, such that the second coupling protrusion is inserted.

According to the disclosure, a filter module can be installed on a shaft of a shelf, which can exclude a separate installation space for a filter inside an inner case, thereby increasing the efficiency of utilizing a storage space and being advantageous in terms of packaging.

According to the disclosure, by coupling a coupling housing and a receiving housing, the filter module can be installed on shafts, allowing a user to easily install, replace, and remove a deodorizing filter module without additional tools or components.

According to the disclosure, a receiving housing can include a mounting portion and a coupling housing may include a guide rib, so that the receiving housing can slide relative to the coupling housing, and a user can easily attach or detach the receiving housing to or from the coupling housing.

According to the disclosure, a filter module can be installed on a shaft, which is existing component. This can allow a user to easily install, replace, and remove a deodorizing filter module without additional tools or components.

According to the disclosure, a filter module can be arranged on a shelf, so that a user can easily recognize and take into account the filter, and can easily replace the filter.

According to the disclosure, fresher air can be supplied to a user using a refrigerator and user discomfort caused by odors can be reduced.

According to the disclosure, a coupling housing can include a first slot and a second slot, so as to be stably and easily coupled to a front shaft and a rear shaft.

According to the disclosure, a filter module can include a coupling member which is detachably coupled to a shaft while surrounding a portion of the shaft, thereby being stably coupled in a direction crossing a direction of a shelf.

### BRIEF DESCRIPTION OF THE DRAWINGS

The above and other aspects, features and other advantages of the disclosure will be more clearly understood from the following detailed description taken in conjunction with the accompanying drawings, in which:

FIG. 1 is a perspective view of a refrigerator according to the disclosure;

FIG. 2 is a front view of a refrigerator according to the disclosure;

FIG. 3 is a perspective view of an example of a filter module according to the disclosure installed on a shelf, viewed from the top;

FIG. 4 is a perspective view of a filter module according to the disclosure;

FIG. 5 is a perspective view of an example of a filter module according to the disclosure installed on a shelf, viewed from the bottom;

FIG. 6 is a perspective view of an example of a filter module detached from a shelf, viewed from the bottom;

FIG. 7 is an exploded perspective view of a filter module according to the disclosure;

FIG. 8 is a conceptual view of an example in which a receiving housing for receiving a filter member is partially detached from a coupling housing;

FIGS. 9A to 9C are conceptual views of a process of installing a filter member on a support portion of a receiving housing;

FIG. 10 is a perspective view of an example of a filter module installed on a shelf in a refrigerator, viewed from the bottom;

FIG. 11 is a conceptual diagram of a flow of cold air in a refrigerating chamber;

FIG. 12 is a conceptual view of a flow of cold air in a filter module;

FIGS. 13A to 13E are conceptual views of a process of coupling a coupling housing to a shaft of a shelf;

FIGS. 14A to 14C are conceptual views of a process of removing a receiving housing from a coupling housing;

FIGS. 15A and 15B are conceptual views of the coupling relationship between a receiving housing and a coupling housing;

FIG. 16 is a perspective view of an example in which a filter module is arranged on a left side of a tray;

FIG. 17 is a perspective view of a filter module having a receiving housing in which a pressing portion is positioned on the front left;

FIG. 18 is a perspective view of an example in which a filter module crosses a shelf and is arranged on one side of a shelf;

FIG. 19 is a perspective view of a filter module of FIG. 18;

FIG. 20 is a perspective view of an example in which a filter module crosses a shelf and is arranged on the other side of the shelf;

FIG. 21 is a front view of an example in which a filter module crosses a shelf and is arranged on a rear side of a shelf;

FIG. 22 is a perspective view of FIG. 21;

FIG. 23 is a perspective view of an example in which a filter module is arranged on a rear side of a shelf to cross the shelf; and

FIG. 24 is an exploded perspective view of the filter module of FIG. 23.

### DETAILED DESCRIPTION

Hereinafter, a refrigerator 1 according to an embodiment of the disclosure will be described in detail with reference to the accompanying drawings. When adding reference numerals to components on each drawing, it should be noted that the same or equivalent components are given the same or equivalent reference numerals even if they are shown on different drawings. In describing an embodiment of the disclosure, when a detailed description of a related known configuration or function is determined to obscure understanding of the embodiment of the disclosure, the detailed description is omitted.

In describing components of an embodiment of the disclosure, terms including ordinal numbers, such as first, second, and the like, may be used to describe various components, but the components are not limited by the terms. These terms are generally only used to distinguish one element from another.

It will be understood that when an element is referred to as being “connected to” or “coupled to” another element, the element may be connected to or coupled to the another element or intervening elements may also be present.

A singular representation as used herein may include a plural representation unless it represents a definitely different meaning from the context.

In the disclosure, the front refers to a direction in which a door is arranged, that is, a direction close to a location where a user stands when using a refrigerator 1, and the rear refers to a direction toward a side corresponding to an inner wall, which is viewed from the front of the refrigerator when a door 14 is open, or a surface of a case 11 opposite to the door 14. In the disclosure, left and right sides are respectively named parts which are viewed based on a direction in which the user looks at the inside of the refrigerator. A lower side is defined as a direction toward the ground, and an upper side is defined as a direction opposite to the ground.

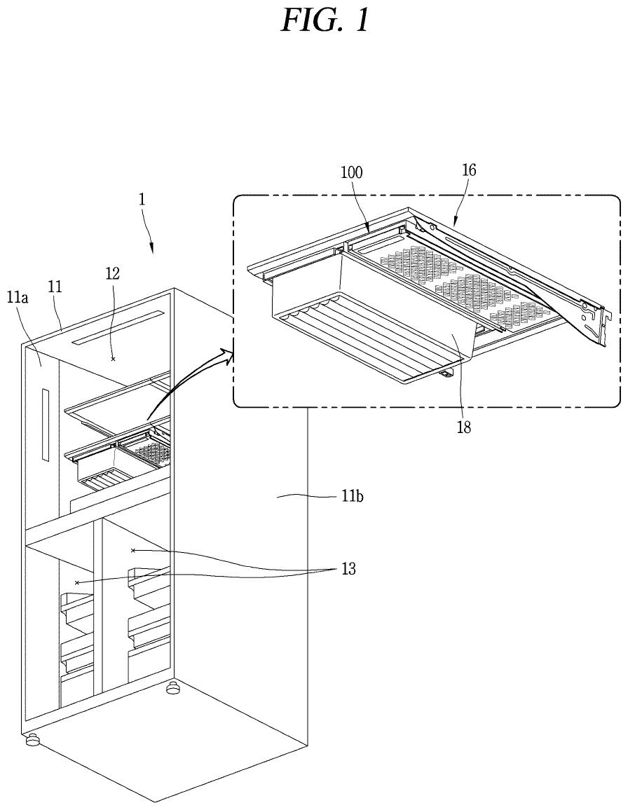

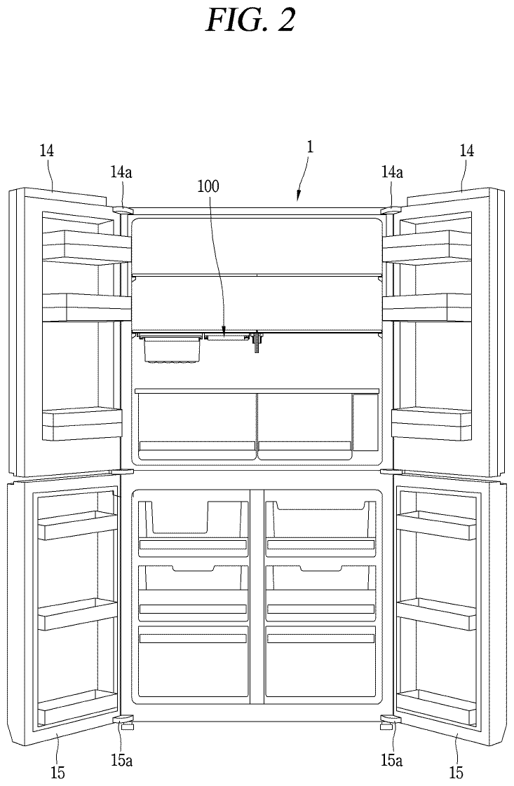

FIG. 1 is a perspective view of a refrigerator 1 according to the disclosure. FIG. 2 is a front view of the refrigerator 1.

Hereinafter, a refrigerator 1 according to the disclosure will be described with reference to FIGS. 1 and 2.

FIGS. 1 and 2 show a refrigerator 1 according to an embodiment.

As shown in FIGS. 1 and 2, a refrigerator 1 according to the disclosure include a case 11 forming a storage space divided into a refrigerating chamber 12 and a freezing chamber 13, a refrigerating chamber door 14 for opening and closing the refrigerating chamber 12, and a freezing chamber door 15 for opening and closing the freezing chamber 13.

The storage space refers to an inner space of the refrigerator 1 in which fresh or frozen food is stored.

The case 11 may include an outer case 11b forming an outer surface, and an inner case 11a which is coupled to the outer case 11b and forms the storage space inside the refrigerator 1.

The outer case 11b may be formed of a metal material. The inner case 11b may be formed of a resin material.

An insulating material may be filled between the outer case 11b and the inner case 11a to insulate an inner space of the refrigerator 1.

The refrigerating chamber 12 is open and closed by doors 14 respectively arranged on left and right sides.

The refrigerating chamber doors 14 include a left refrigerating chamber door 14 rotatably connected to the left side of the case 11, and a right refrigerating chamber door 14 rotatably connected to the right side of the case 11.

The refrigerating chamber 12 is open by the left door and the right door to form one chamber, but in some cases, left and right chambers may be individually formed. The refrigerating chamber doors 14 are rotatably connected to the case 11.

Hinge portions 14a rotatably connect the corresponding refrigerating chamber doors 14 to the case 11.

The hinge portions 14a may include a hinge portion 14a connecting the left refrigerating chamber door 14 to the case 11 and a hinge portion 14a connecting the right refrigerating chamber door 14 to the case 11.

The hinge portion 14a connecting the left refrigerating chamber door 14 may have the same structure as the hinge portion 14a connecting the right refrigerating chamber door 14.

Each of the hinge portions 14a includes a door switch (not shown). When the right refrigerating chamber door 14 is open and closed, the corresponding door switch comes into contact to turn on/off a light (not shown) illuminating the refrigerating chamber 12.

The door switch turns the light off when the right refrigerating chamber door 14 is closed, and turns the light on when the right refrigerating chamber door 14 is open.

The door switch may further include a door switch connector (not shown). The door switch may detect whether the refrigerating chamber door is open or closed as the door switch connector is inserted.

The freezing chamber 13 also includes freezing chamber doors 15 which are open and closed left and right.

In some cases, the freezing chamber 13 may be coupled to slide along the case 11 and configured to store food.

In this case, the freezing chamber door 15 seals the freezing chamber 13 when it is drawn in by sliding toward the inside of the case 11, and opens the freezing chamber 13 when it is pulled out from the case 11.

The refrigerator 1 may further include a separate storage chamber which is slidable.

For convenience of explanation and understanding, the embodiment according to the disclosure shows a four-door side-by-side type refrigerator 1 in which a refrigerating chamber is located at the top and a freezing chamber is located at the bottom. However, the disclosure is not necessarily limited thereto, and may be applied to all types of refrigerators 1 in which a shelf 16 is arranged in a storage chamber of the refrigerator 1.

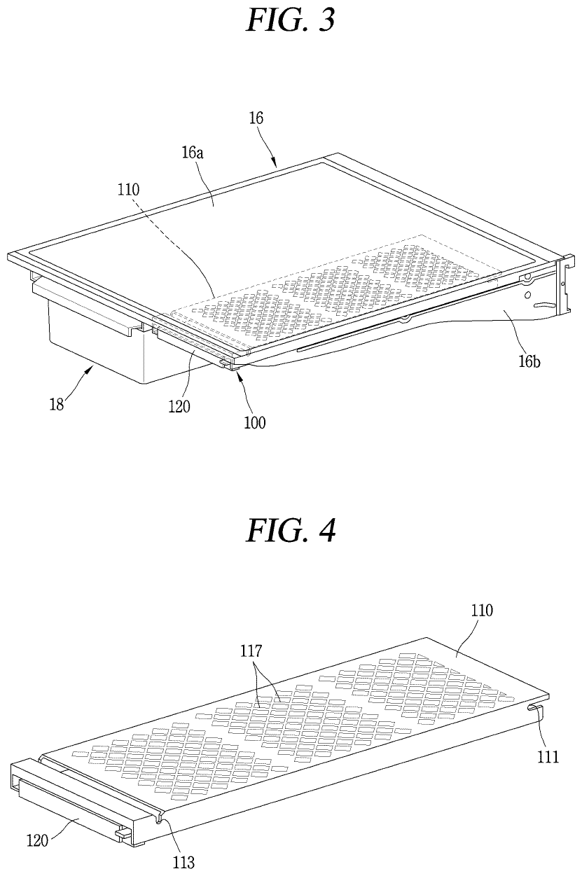

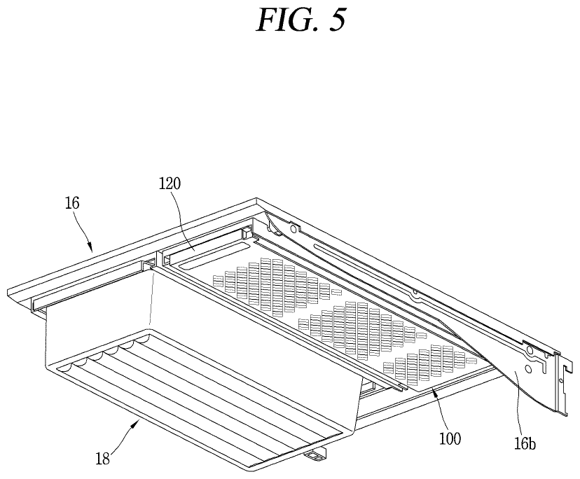

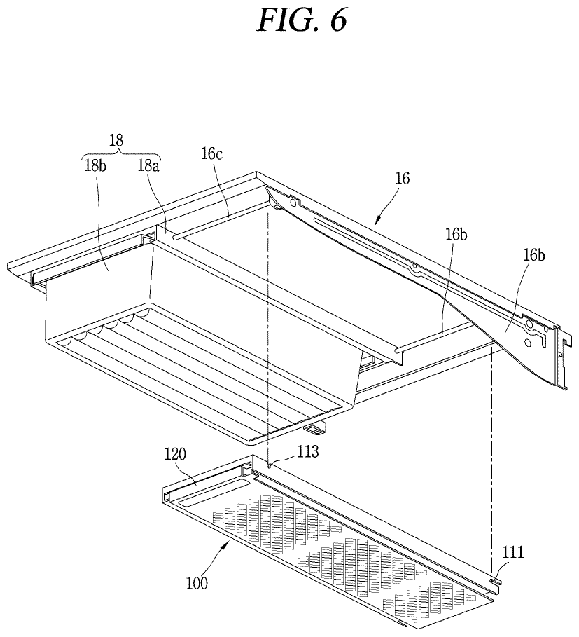

FIG. 3 is a perspective view of an example of a filter module 100 according to the disclosure installed on a shelf 16, viewed from the top, and FIG. 4 is a perspective view of the filter module 100. FIG. 5 is a perspective view of an example of the filter module 100 according to the disclosure installed on the shelf, viewed from the bottom. FIG. 6 is a perspective view of an example of the filter module 100 detached from the shelf 16, viewed from the bottom.

Hereinafter, a filter module 100 according to the disclosure will be described, with reference to FIGS. 3 to 6.

The refrigerator 1 according to the disclosure includes a case 11 having a storage space with one side open, a door 14 provided on the case 11 and opening and closing the storage space, a shelf 16 installed inside the case 11 in the storage space, at least two shafts 16c installed at the shelf 16 to be spaced apart from each other, and a filter module 100 including a filter member 130 and detachably installed on the shafts 16c.

The disclosure is designed to develop a structure which can utilize existing shaft guides below a shelf and easily attach a deodorizing filter without any special tools.

According to the disclosure, the filter module 100 may be installed on the shaft 16c which is installed on the existing shelf 16 without any additional components.

In some embodiments, the filter module 100 may be arranged parallel to the shelf 16 or may be arranged in a direction crossing the shelf 16.

When the filter module 100 is arranged parallel to the shelf 16, the filter module 100 may be arranged below the shelf 16 at a predetermined gap from the shelf 16.

When the filter module 100 is arranged to cross the shelf 16, the filter module 100 may be arranged on one side or a rear side of the shelf 16.

First, an example in which the filter module 100 is arranged parallel to the shelf 16 will be described.

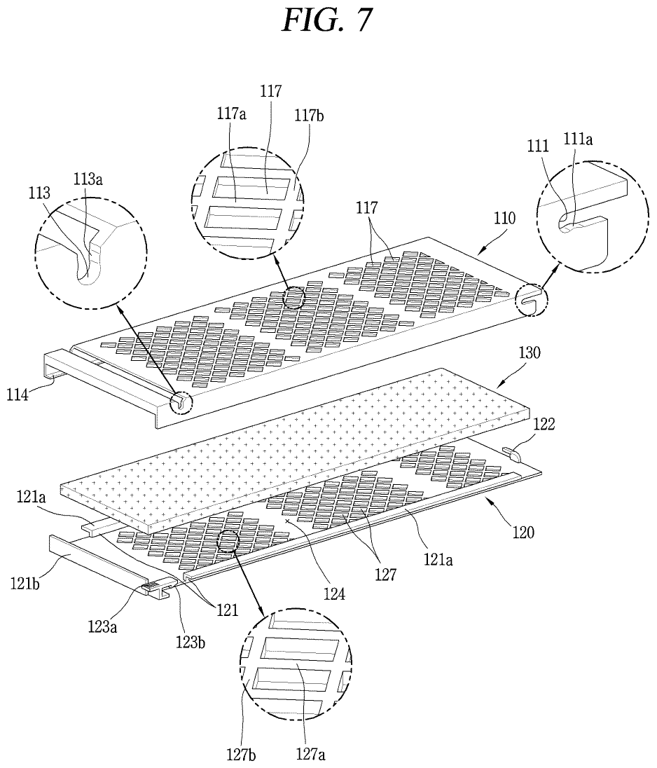

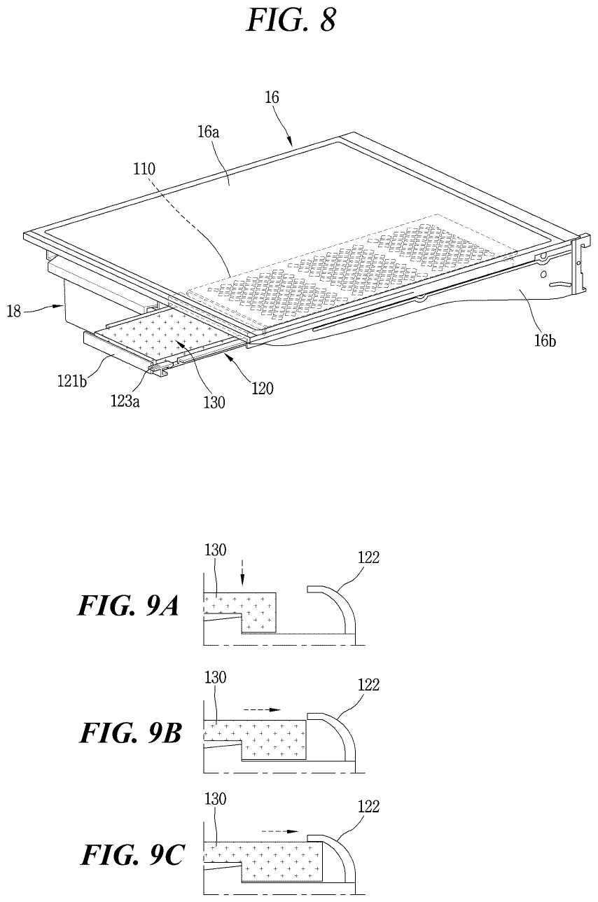

FIG. 7 is an exploded perspective view of the filter module 100, and FIG. 8 is a conceptual view of an example in which a receiving housing 120 for receiving a filter member is partially detached from a coupling housing 110. FIGS. 9A to 9C are conceptual view of a process of installing a filter member on a support portion 122 of the receiving housing 120. FIG. 10 is a perspective view of an example of the filter module 100 installed on the shelf 16 in the refrigerator, viewed from the bottom.

An example in which the filter module 100 is arranged parallel to the shelf 16 will be described with reference to FIGS. 7 to 10.

The filter module 100 includes a coupling housing 110, a receiving housing 120, and a filter member 130.

The coupling housing 110 may be detachably arranged on the shaft 16c.

In the disclosure, the coupling housing 110 may also be referred to as a first housing.

The receiving housing 120 may be installed on the coupling housing 110 and may include an accommodation space 124 in which the filter member 130 is accommodated.

For example, in order for a user to easily install and replace the filter module 100, the coupling housing 110 may first be installed on the shaft 16c, and the receiving housing 120, in which the filter member 130 is accommodated in the accommodation space 124, may be coupled to the coupling housing 110.

In the disclosure, the receiving housing 120 may also be referred to as a second housing.

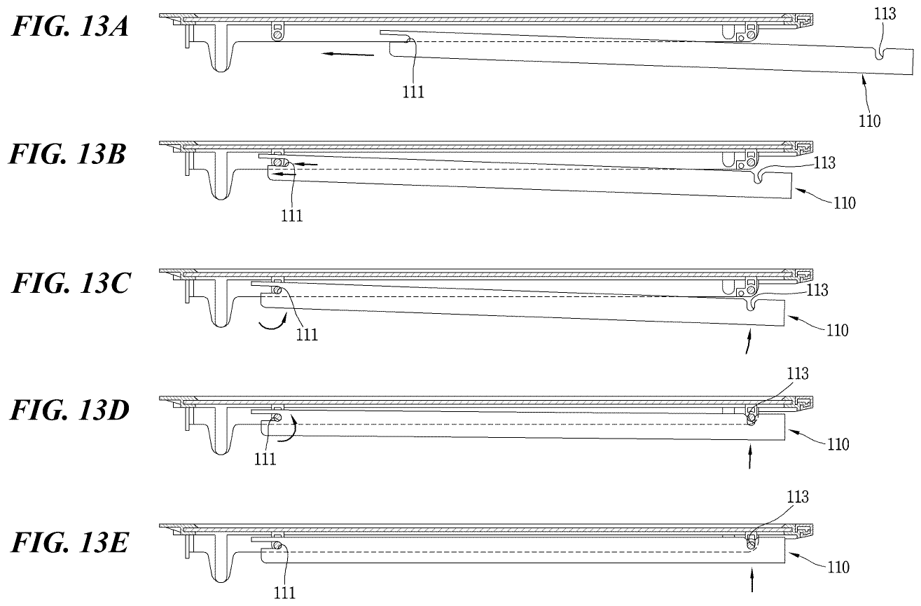

FIGS. 13A to 13E are conceptual views of a process of coupling the coupling housing 110 to the shaft 16c of the shelf 16.

A coupling structure between the coupling housing 110 and the shaft 16c will be described with reference to FIGS. 13A to 13E.

The coupling structure between the coupling housing 110 and the shaft 16c will be described.

First, the structure of the shaft 16c will be described. The shaft 16c may be understood by referring to FIG. 6.

The shaft 16c may be arranged as at least two shafts spaced apart from each other on the shelf 16.

For example, the shaft 16c may be arranged as two shafts which may be installed at the bottom of the shelf 16. The two shafts 16c are arranged to extend in left and right directions. The two shafts 16c may be spaced apart in forward and backward directions.

The shaft 16c is located below the shelf 16 and the filter module 100 is installed at the bottom of the shelfs 16, thereby securing a sufficient space for assembling and disassembling the filter module 100.

A tray 18 for accommodating food may be installed on the shaft 16c. The tray 18 may include a coupling portion 18a coupled to the shaft 16c and a storage portion 18b for storing food.

The coupling portion 18a of the tray 18 may include coupling holes so that the coupling portion 18a is installed on the shaft 16c. The coupling portion 18a of the tray 18 may be installed to be movable relative to the shaft 16c along the shaft 16c.

Accordingly, an installation position of the filter module 100 may also be determined by taking into consideration the position of the coupling portion 18a of the tray 18.

For example, when the coupling portion 18a of the tray 18 is arranged on the left side below the shelf 16, the filter module 100 may be arranged on the right side below the shelf 16.

In another example, when the coupling portion 18a of the tray 18 is arranged on the right side below the shelf 16, the filter module 100 may be arranged on the left side below the shelf 16.

The storage portion 18b of the tray 18 may have a food storage space in which food can be stored. As shown in FIGS. 5 and 6, the storage portion 18b may have a shape roughly like a rectangular parallelepiped.

The storage portion 18b of the tray 18 may be installed to be movable relative to the coupling portion 18a of the tray 18. For example, one of the storage portion 18b or the coupling portion 18a of the tray 18 may catch the other, such that the storage portion 18b of the tray 18 can slide relative to the coupling portion 18a.

To stably couple the tray 18 to the shaft 16c, the shaft 16c may be arranged as at least two shafts, and it is preferable that the at least two shafts 16c are sufficiently spaced apart from each other.

In FIG. 6, the shaft 16c is arranged to extend in the left and right directions. In particular, an example is shown in which the two shafts 16c are arranged sufficiently spaced apart from each other on the front side and the rear side, respectively.

The shaft 16c may be designed with a rod shape with a predetermined diameter.

This can minimize damage to the coupling housing 110 during a process of installing, assembling, or removing the coupling housing 110 to be described later.

During the process of installing, assembling, or removing the coupling housing 110, one side of the shaft 16c may serve as a structure for inducing rotation, which may more facilitate the process.

Hereinafter, the structure of the shelf 16 will be described. The shelf 16, as shown in FIG. 6, may include a food support plate 16a on which food or a container for storing food can be placed, coupling side portions 16b arranged on opposite side portions of the food support plate 16a, and a shaft 16c extending between the opposite coupling-side portions 16b below the food support plate 16a.

The food support plate 16a may be made of a transparent material so that the filter module 100 below the shelf 16 is visible.

Accordingly, the user can visually recognize the presence of the filter module 100 below the shelf 16 even at normal times, and thus can psychologically feel comfortable air while taking interest in the replacement of the filter member 130.

The coupling side portions 16b may be coupled to the inner case 11a.

For example, referring to FIGS. 1 and 2, the left coupling side portion 16b may be coupled to the inner case 11a of a left end. The right coupling side portion 16b may be coupled to a rear wall of the inner case 11a. In another example, when the right coupling side portion 16b is in contact with the inner case 11a of a right end, the right coupling side portion 16b may be coupled to the inner case 11a of the right end.

The coupling side portion 16b may be coupled to the inner case 11a by means of bolts or in a press-fitting manner, and is the conventional technology, thus a detailed description will be omitted.

Referring to FIGS. 7 and 13, the coupling housing 110 may include a first slot 111 and a second slot 113.

The first slot 111 may be arranged on one side of the coupling housing 110, and may be formed concavely in a first direction so that the filter module 100 is guided and mounted on one of the shafts 16c.

For example, the first slot 111 may be positioned on the rear side of the coupling housing 110 and may be formed to be concave toward the front. The first slot 111 may be arranged on each of opposite sides at the rear of the coupling housing 110.

An anti-separation portion 111a may be formed in the first slot 111.

The anti-separation portion 111a protrudes from an end portion of the first slot 111 by a predetermined distance in a second direction crossing the first direction, to suppress the separation of one shaft 16c.

The second slot 113 may be located on the other side of the coupling housing 110 opposite to the one side. The second slot 113 may be concave in the second direction crossing the first direction, so that the filter module 100 can be secondarily coupled after being primarily mounted on the first slot 111.

For example, the second slot 113 may be located in the vicinity of the front side of the coupling housing 110 and may be concave in up and down directions.

An anti-separation portion 113a may be formed in the second slot 113.

The anti-separation portion 113a protrudes from an end portion of the second slot 113 by a predetermined distance in the first direction, to suppress the separation of the other shaft 16c.

Referring to FIGS. 7 and 13, the first slot 111 which is formed toward the front (the left-right direction in the drawing) in a rear end portion of the coupling housing 110 is shown.

The first slot 111 may be arranged in the rear end of each of opposite side walls of the coupling housing 110.

The first slot 111 preferably has an inner width which is approximately the same as a diameter of the shaft 16c and has a sufficient depth to stably accommodate the shaft 16c.

The first slot 111 allows the coupling housing 110 to be primarily mounted on the shaft 16c.

In the shown example, the anti-separation portion 111a protrudes from the first slot 111 to suppress the shaft 16c, which has been inserted into the first slot 111, from being moved in the forward and backward directions or separated.

For example, the separation of the first slot 111 may be suppressed in the state where the shaft 16c has been fully inserted into the first slot 111.

However, the first slot 111 can rotate centering around the shaft 16c, which has the rod shape, while the separation of the first slot 111 from the shaft 16c can be suppressed by the anti-separation portion 111a. This can facilitate coupling of the second slot 113 to the other shaft 16c.

It is preferable that the anti-separation portion 111a of the first slot 111 allow the insertion of the shaft 16c into the first slot 111 and, in the state where the shaft 16c has been inserted into the first slot 111, suppress the separation of the first slot 111 from the shaft 16c before a user applies external force.

An example is shown in which the second slot 113 is formed on an upper surface of the front side of the coupling housing 110.

After the first slot 111 is coupled to the shaft 16c located on the rear side, the second slot 113 is coupled to the shaft 16c located on the front side.

The second slot 113 may be formed to couple the shaft 16c from the upper front side in opposite side directions.

It is preferable that the second slot 113 be positioned at a predetermined distance from the front end portion of the coupling housing 110 for the convenience of the user who inserts and withdraws the receiving housing 120.

In the shown example, the anti-separation portion 113a protrudes from an upper end portion of the second slot 113 to suppress the shaft 16c, which has been inserted into the second slot 113, from being moved in the up and down directions or separated.

It is preferable that the anti-separation portion 113a of the second slot 113 allow the insertion of the shaft 16c into the second slot 113 and, in the state where the shaft 16c has been inserted into the second slot 113, suppress the separation of the second slot 113 from the shaft 16c before the user applies external force.

Referring to FIGS. 7 and 8, the receiving housing 120 may be installed to be slidable relative to the coupling housing 110.

For example, the receiving housing 120 may include mounting portions 121a.

The mounting portions 121a may be formed by being outwardly bent at end portions of opposite side walls 121 of the receiving housing 120, which forms the accommodation space 124.

The coupling housing 110 may include guide ribs 114.

The guide ribs 114 may be arranged on opposite side walls of the coupling housing 110 to support lower sides of the mounting portions 121a, and thus the mounting portions 121a may be connected to be slidable on the guide ribs 114.

For example, the guide ribs 114 may be formed by being inwardly bent at end portions of the opposite side walls of the coupling housing 110.

The mounting portions 121a and the guide ribs 114 enable the receiving housing 120 to slide relative to the coupling housing 110.

Accordingly, the user can install the filter member 130 in the accommodation space 124 of the receiving housing 120 and then install the receiving housing 10 on the coupling housing 110 in the sliding manner.

The user can also easily detach or separate the receiving housing 10 from the coupling housing 110 upon replacing or repairing the filter member 130.

Of course, the user does not necessarily have to couple the receiving housing 120 to the coupling housing 110 after coupling the coupling housing 110 to the shaft 16c, but can first assemble the receiving housing 10 with the coupling housing 110 in the sliding manner and then couple the coupling housing, assembled with the receiving housing 10, to the shaft 16c.

The filter member 130 is installed in the accommodation space 124 formed in the receiving housing 120.

The filter member 130 removes odors contained in cold air while the cold air passes therethrough.

For example, the filter member 130 may include zeolite, silica, carbon fiber, and activated carbon. The filter member 130 may include a structure having a plurality of holes, a porous material, and a mesh structure. For this reason, the filter member 130 preferably has a wide cross-sectional area in contact with cold air when the cold air containing odors passes therethrough, to maximize a deodorizing effect.

For example, the filter member 130 may be a flat plate having a predetermined thickness. This structure of the filter member 130 is advantageous of collecting odor substances from cold air containing odors while the cold air passes through the filter member 130, and minimizing the flow resistance of the cold air, thereby suppressing the deterioration of refrigeration performance.

The filter member 130 may include a substance with a specific scent. For example, the filter member 130 may include a substance emitting an aroma. This allows the user to experience a more pleasant sense of smell in addition to simply eliminating odors.

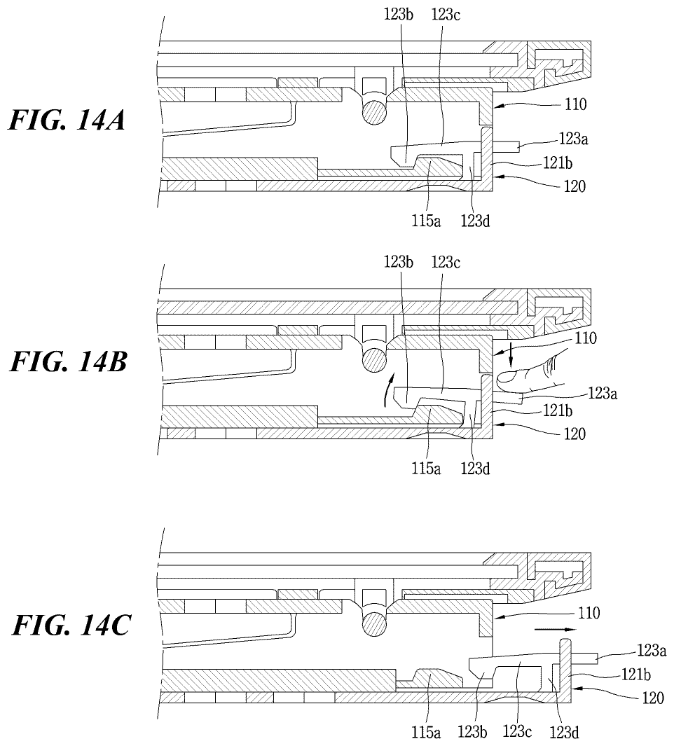

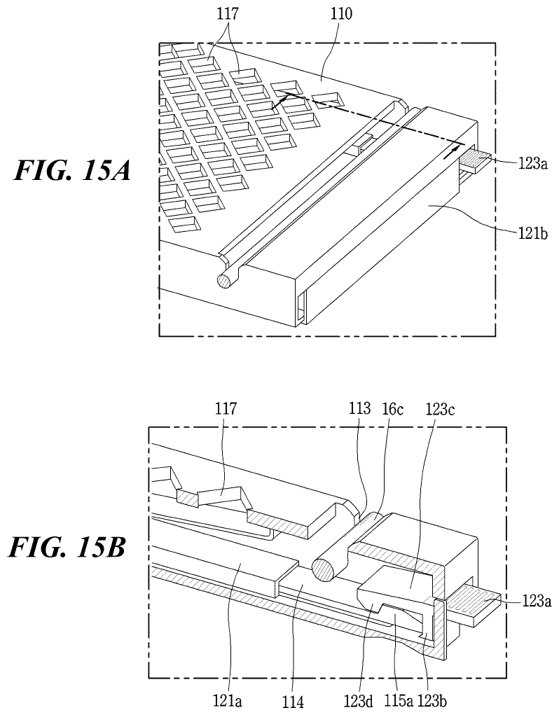

FIG. 14A to 14C are conceptual views of a process of detaching the receiving housing 120 from the coupling housing 110. FIGS. 15A and 15B are conceptual view of a coupling relationship between the receiving housing 120 and the coupling housing 110.

Hereinafter, the coupling relationship between the receiving housing 120 and the coupling housing 110 will described, with reference to FIGS. 14A to 14C and FIGS. 15A and 15B.

The receiving housing 120 may include a pressing portion 123a and a stopping protrusion 123b.

The pressing portion 123a may be configured to be pressed by the user.

The pressing portion 123a may be arranged on the outside to be easily manipulated by the user.

The stopping protrusion 123b may be connected to the pressing portion 123a and may protrude from one side opposite to the pressing portion 123a.

The stopping protrusion 123b may, for example, protrude from one end portion opposite to the pressing portion 123a.

For example, the stopping protrusion 123b may protrude in a direction crossing the pressing portion 123a.

The coupling housing 110 may include a stopping rib 115a.

The stopping rib 115a may be formed to catch and fix the stopping protrusion 123b in a state that the receiving housing 120 has been inserted.

Accordingly, the stopping protrusion 123b may catch the stopping rib 115a in the state that the receiving housing 120 has been inserted into the coupling housing 110, so that the receiving housing 120 and the coupling housing 110 can be stably coupled to each other.

When the user presses the pressing portion 123a, the stopping protrusion 123b may be released from the stopping rib 115a, so that the receiving housing 120 can be withdrawn from the coupling housing 110, and the user can easily detach the receiving housing 120 from the coupling housing 110.

The receiving housing 120 may further include an extension portion 123c and an elastic support portion 123d.

The extension portion 123c may extend between the pressing portion 123a and the stopping protrusion 123b.

The extension portion 123c may elastically move the stopping protrusion 123b upward when the pressing portion 123a is pressed.

For example, the extension portion 123c elastically connects the pressing portion 123a and the stopping protrusion 123b.

The elastic support portion 123d may extend from a middle portion of the extension portion 123c in a direction crossing the extension portion 123c, and an end of the elastic support portion 123d may protrude to elastically support the stopping rib 115a.

In a state where the stopping protrusion 123b catches one side of the stopping rib 115a, the elastic support portion 123d may support the other side of the stopping rib 115a opposite to the one side.

The elastic support portion 123d may be, for example, formed in a bent shape and support the stopping rib 115a by receiving the stopping rib 115 inward.

The elastic support portion 123d can more stably support the stopping protrusion 123b and the stopping rib 115a, and allow the receiving housing 120 to be more stably coupled to and removed from the coupling housing 110.

The receiving housing 120 may include side walls 121 and support portions 122.

The side walls 121 may form walls with a predetermined thickness on opposite sides of the receiving housing 120.

On both end portions of the side wall 121, the support portions 122 may be formed by being bent outward, as described above.

The accommodation space 124 may be located between the opposite side walls 121 to accommodate the filter member 130.

The filter member 130 is preferably sized so that its opposite sides are supported by the side walls 121.

The support member 122 may be formed with at least a portion bent or curved to support the filter member 130 from the other side.

Referring to FIGS. 7 to 9, an example is shown in which, in a state where the filter member is accommodated in the accommodation space 124, both sides of the filter member 130 are supported by the side walls 121 located on both sides of the receiving housing 120, and the rear side of the filter member 130 is supported by the support member 122.

Referring to FIGS. 5 and 6, the refrigerator 1 according to the disclosure may further include a tray 18.

The tray 18 may include a coupling portion 18a coupled to the shaft 16c and a storage portion 18b for storing food.

The coupling portion 18a of the tray 18 may include coupling holes so that the coupling portion 18a is installed on the shaft 16c. The coupling portion 18a of the tray 18 may be installed to be movable relative to the shaft 16c along the shaft 16c.

Accordingly, an installation position of the filter module 100 may also be determined by taking into consideration the position of the coupling portion 18a of the tray 18.

For example, when the coupling portion 18a of the tray 18 is arranged on the left side below the shelf 16, the filter module 100 may be arranged on the right side below the shelf 16.

In another example, when the coupling portion 18a of the tray 18 is arranged on the right side below the shelf 16, the filter module 100 may be arranged on the left side below the shelf 16.

The storage portion 18b of the tray 18 may have a food storage space in which food can be stored. As shown in FIGS. 5 and 6, the storage portion 18b may have a shape roughly like a rectangular parallelepiped.

The storage portion 18b of the tray 18 may be installed to be movable relative to the coupling portion 18a of the tray 18. For example, one of the storage portion 18b or the coupling portion 18a of the tray 18 may catch the other, such that the storage portion 18b of the tray 18 can slide relative to the coupling portion 18a.

The coupling portion 18a of the tray 18 may be arranged to be movable along the shaft 16c.

As the tray 18 is arranged to be movable relative to the shafts 16c, the filter module 100 may be arranged on one side or the other side of the tray 18 with respect to the tray 18.

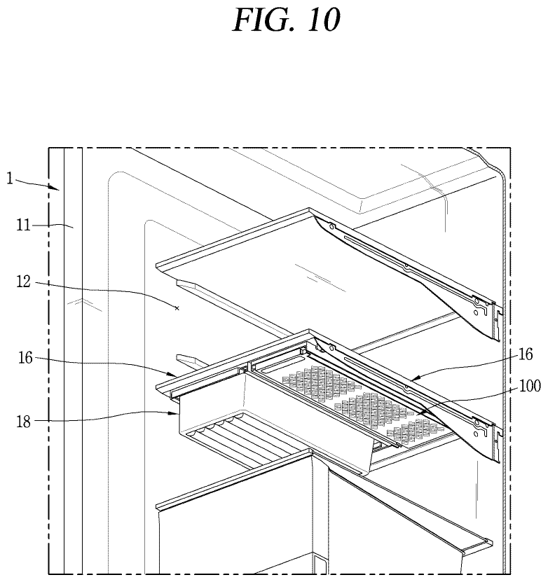

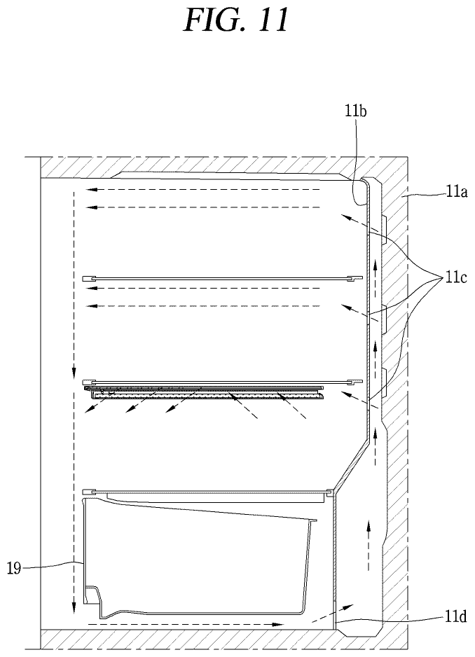

In some embodiments, a cold air discharge port 11c (FIG. 11) is arranged in the case 11.

Cold air generated in the evaporator 13 flows along a duct, which is accommodated between the inner case 11a and the outer case 11b, by the operation of the blower fan 14, and is discharged forward into the storage space of the refrigerating chamber 12 through the cold air discharge port 11c, which is positioned on the rear wall of the storage space in the inner case 11a.

A cold air recovery port 11d (FIG. 11) is arranged in the case 11. The cold air recovery port 11d allows cold air whose temperature has risen after flowing in the storage space to be recovered through the duct which is accommodated between the inner case 11a and the outer case 11b. For example, the cold air recovery port 11d may be arranged on a lower portion of the refrigerating chamber 12.

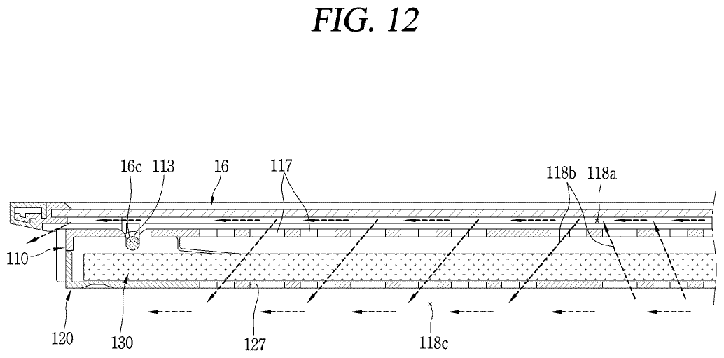

FIG. 11 is a conceptual diagram of a flow of cold air in a refrigerating chamber. FIG. 12 is a conceptual view of a flow of cold air in the filter module 100.

Hereinafter, the flow around the filter module 100 according to the disclosure will be described with reference to FIGS. 11 and 12.

The filter module 100 may include a first flow path 118a and a second flow path 118b.

The first flow path 118a is positioned between the coupling housing 110 and the shelf 16. The coupling housing 110 is arranged spaced apart from the shelf 16 by a predetermined distance, and cold air may flow between the coupling housing 110 and the shelf 16. A space between the coupling housing 110 and the shelf 16 may be defined as the first flow path 118a.

In FIG. 12, an example is shown in which the coupling housing 110 is arranged to be spaced apart from the food support plate 16a of the shelf 16 by a predetermined distance, and the first flow path 118a is defined between the coupling housing 110 and the food support plate 16a of the shelf 16.

The second flow path 118b may cross the first flow path 118a.

The second flow path 118b may be a flow path passing through the filter module 100.

To form the second flow path 118b, cold air passage holes 117 and 127 through which cold air can flow may be formed through the coupling housing 110 and the receiving housing 120.

In the disclosure, the cold air passage holes 117 and 127 may be cut windows.

The second flow path 118b may be a flow path through which air is discharged from the first flow path into the lower portion of the receiving housing 120 through the filter module 100, or a flow path through which air is introduced from the lower portion of the receiving housing 120 into the first flow path 118a through the filter module 100.

For example, the second flow path 118b may be understood as a flow path extending through the cold air passage hole 117 of the coupling housing 110 and the cold air passage hole 127 of the receiving housing 120.

The filter module 100 may further include a third flow path 118c.

The third flow path 118c may be a flow path, through which cold air flows, below the receiving housing 120. Some of cold air passing through the third flow path 118c may pass through the cold air passage hole 127 of the receiving housing 120, and may be discharged through the cold air passage hole 117 of the coupling housing 110 via the filter member 130. For example, some of cold air passing through the third flow path 118c may pass through the second and first flow paths 118b and 118a.

Hereinafter, the cold air passage holes 117 and 127 formed in the filter module 100 will be described.

Cold air inside the refrigerator may be introduced into the accommodation space 124 or discharged from the accommodation space 124 through the cold air passage holes 117 and 127.

The cold air passage holes 117 and 127 may each be arranged as a plurality of holes spaced apart from one another.

The cold air passage holes 117 and 127 may be arranged continuously in the coupling housing 110 and the receiving housing 120.

The cold air passage holes 117 and 127 are preferably formed in as many areas as possible to improve the flow performance of cold air passing through the coupling housing 110 and the receiving housing 120.

In the disclosure, an example is shown in which the cold air passage holes 117 and 127 are formed in approximately half or more of each of the coupling housing 110 and the receiving housing 120.

The cold air passage holes 117 and 127 are formed in the coupling housing 110 and the receiving housing 120 to improve cold air flow performance while maintaining a certain rigidity.

To this end, for example, the coupling housing 110 and the receiving housing 120 may each include first and second partition portions 117a, 117b, 127a, and 127b.

The first partition portions 117a and 127a may extend in diagonal directions of the coupling housing 110 and the receiving housing 120, respectively. The first partition portions 117a and 127a may each be arranged as a plurality of partition walls extending in a spacing manner.

The second partition portions 117b and 127b may cross the first partition portions 117a and 127a, respectively.

The second partition portions 117b and 127b may also be each arranged as a plurality of partition portions extending in a spacing manner.

The first and second partition portions 117a, 117b, 127a, and 127b may have approximately the same structure with a predetermined width, and may be arranged continuously to form the cold air passage holes 117 and 127.

The first and second partition portions 117a, 117b, 127a, and 127b may form the cold air passage holes 117 and 127 each having a polygonal structure.

The first and second partition portions 117a, 117b, 127a, and 127b may form the cold air passage holes 117 and 127 while supporting the filter member 130 not to be separated.

The first slot 111 of the coupling housing 110 is placed on the rear shaft 16c below the shelf 16. At this time, to minimize interference with the shelf 16, the slot 111 is preferably inserted obliquely from the front side of the coupling housing 110 (see FIG. 13A).

The first slot 111 of the coupling housing 110 is fully inserted onto the rear shaft 16c. At this time, the separation of the rear shaft 16c is suppressed by the anti-separation portion 111a of the first slot 111 (see FIGS. 13A and 13C). The anti-separation portion 111a of the first slot 111 may be understood as a fine protrusion.

When the first slot 111 of the coupling housing 110 is fully inserted onto the rear shaft 16c, the coupling housing 110 can rotate around the rear shaft 16c inserted into the first slot 111 as the center of rotation (see FIG. 13C).

Afterwards, while rotating the coupling housing 110 by a predetermined angle centering around the shaft 16c mounted in the first slot 111, as the center of rotation, by listing the front part of the coupling housing 110, the second slot 16c of the coupling housing 110 is then inserted and coupled onto the front shaft 16c (see FIGS. 13D and 13E).

The separation of the front shaft 16c from the second slot 113 is suppressed by the anti-separation portion 113a of the second slot 113.

The anti-separation portion 113a of the second slot 113 may be understood as a fine protrusion.

Afterwards, the receiving housing 120 in which the filter member 130 has been accommodated slides into the coupling housing 110 to be coupled to the coupling housing 110.

The filter member 130 is mounted and coupled to the accommodation space 124 of the receiving housing 120 to be supported by the opposite side walls 121 of the receiving housing 120. For example, the rear side of the filter member 130 is moved toward the rear side and supported by the support portion 122 (see FIG. 7 and FIGS. 9A to 9C).

In the state where the filter member 130 is coupled to the receiving housing 120, the receiving housing 120 may slide to be coupled to the coupling housing 110 (see FIG. 8).

In some embodiments, the mounting portions 121a of the receiving housing 120 are guided by the guide ribs 114 of the coupling housing 110, and the receiving housing 120 moves relative to the coupling housing 110.

While the receiving housing 120 is inserted into the coupling housing 110, although not shown, it is understood with reference to FIG. 14A and FIG. 15B that the stopping protrusion 123b of the receiving housing 120 elastically deforms and passes over the stopping rib 115a of the coupling housing 110.

When the receiving housing 120 is fully inserted into the coupling housing 110, as shown in FIG. 14A and FIG. 15B, the stopping protrusion 123b of the receiving housing 120 is fixed by catching the stopping rib 115a of the coupling housing 110.

To separate the receiving housing 120 from the coupling housing 110 for replacement or repair of the filter member 130, as shown in FIG. 14B, when the user presses the pressing portion 123a, the stopping protrusion 123b is released from the stopping rib 115a, so that the receiving housing 120 can be withdrawn from the coupling housing 110.

Afterwards, as shown in FIG. 14C, the user can detach the receiving housing 120 from the coupling housing 110.

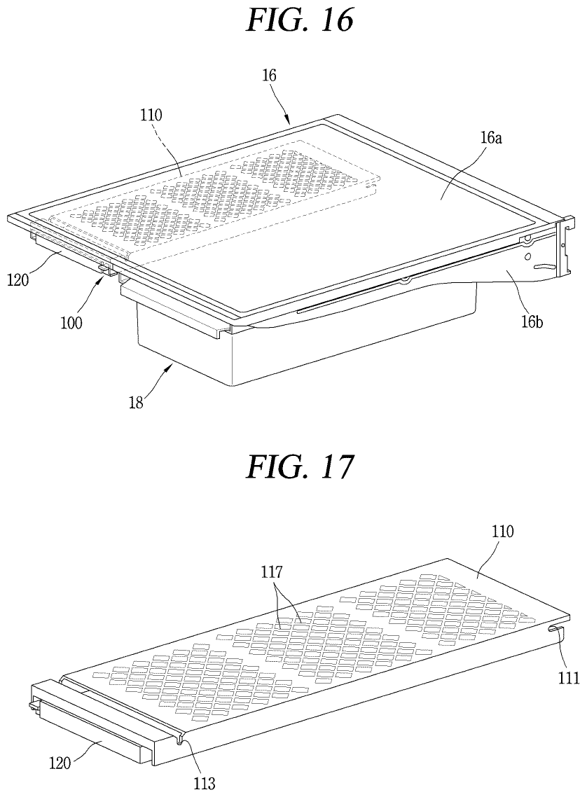

FIG. 16 is a perspective view of an example in which the filter module 100 is arranged on the left side of the tray 18. FIG. 17 is a perspective view of the filter module 100 having the receiving housing 120 in which the pressing portion 123a is positioned on the front left.

The tray 18 may be movable relative to the shaft 16c.

For example, the coupling portion 18a of the tray 18 may be movable relative to the shaft 16c.

Accordingly, the location where the filter module 100 is installed can be adjusted.

For example, as shown in FIG. 16, the filter module 100 may be installed on the left side with respect to the tray 18.

In some embodiments, as shown in FIG. 17, unlike the previous drawings, the pressing portion 123a may be arranged on the front left of the receiving housing 120.

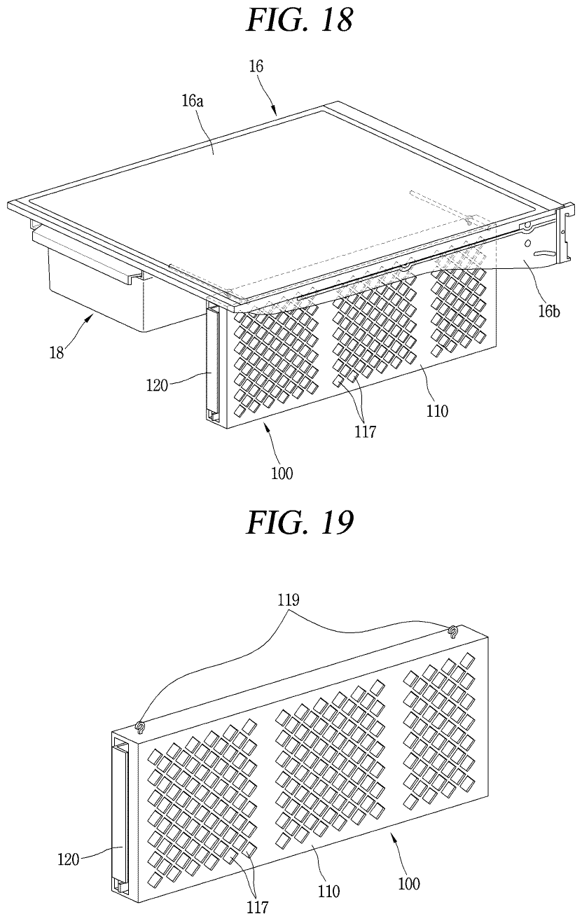

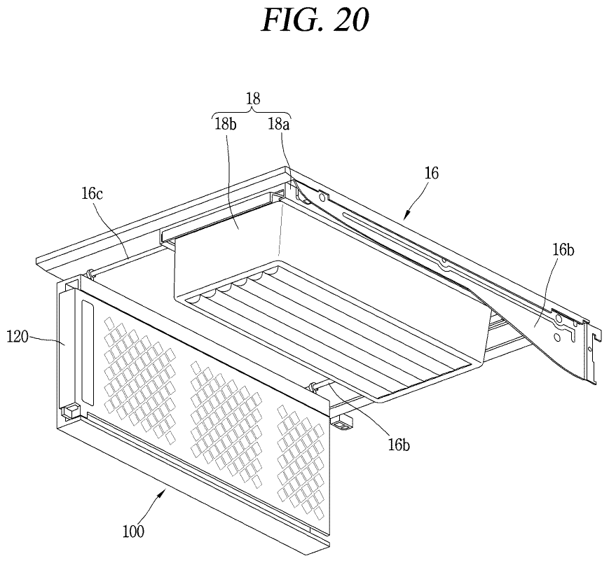

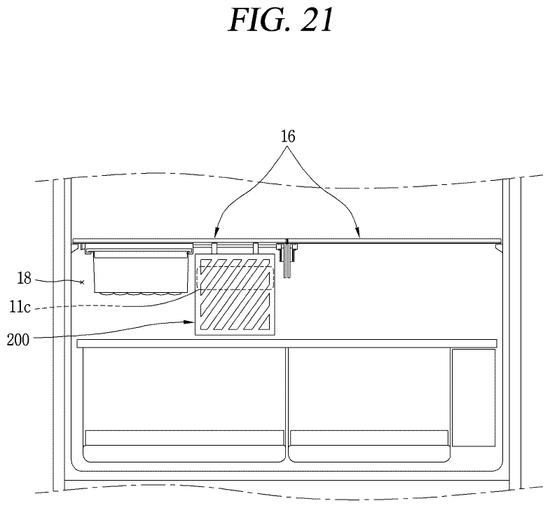

FIG. 18 is a perspective view of an example in which the filter module 100 crosses the shelf 16 and is arranged on one side of the shelf 16. FIG. 19 is a perspective view of the filter module 100 of FIG. 18. FIG. 20 is a perspective view of an example in which the filter module 100 crosses the shelf 16 and is arranged on the other side of the shelf 16.

Hereinafter, the filter module 100 according to another embodiment will be described, with reference to FIGS. 18 to 20.

In some embodiments, the filter module 100 may be arranged parallel to the shelf 16 or may be arranged in a direction crossing the shelf 16.

Hereinafter, an example in which the filter module 100 is arranged on a side portion of the shelf 16 in a direction crossing the shelf 16 will be described.

In relation to this embodiment, any parts not described will be replaced with the description of the previous embodiment.

The coupling housing 110 may include a coupling member 119.

The coupling member 119 may be a curved member which protrudes from one side of the coupling housing 110, surrounds a portion of the shaft 16c, and is detachably coupled to the shaft 16c.

The coupling member 119 may be arranged in a direction that the filter module 100 crosses the shelf 16.

The coupling member 119 may be elastically deformable so as not to break when coupled to or uncoupled from the shaft 16c.

The filter module 100 may be arranged parallel to the inner wall of the case 11 near the inner wall of the case 11.

The coupling member 119 may be arranged as two coupling members. The two coupling members 119 may be arranged to be spaced apart from each other. The two coupling members 119 are coupled to the two shafts 16c.

As in this embodiment, the coupling member 119 can be arranged on the coupling housing 110 to be coupled to the shaft 16, and thus the first and second slots 111 and 113 are excluded.

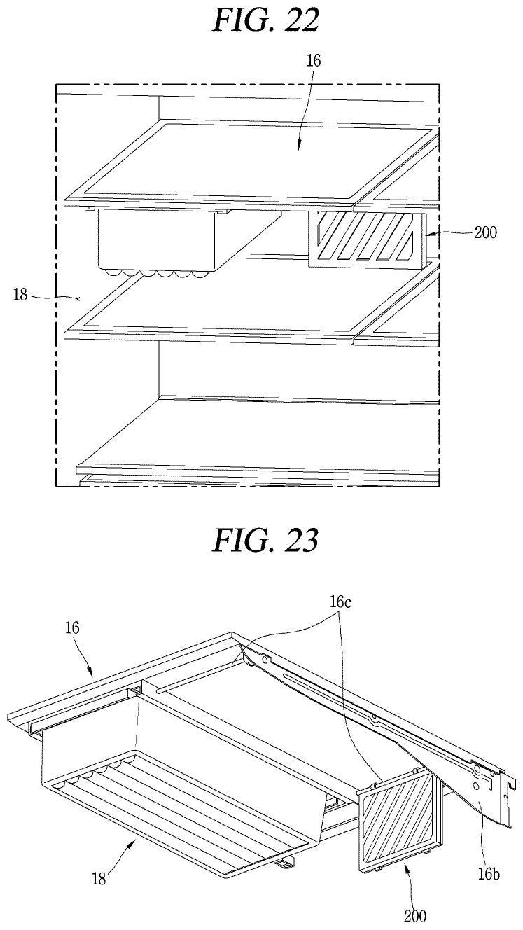

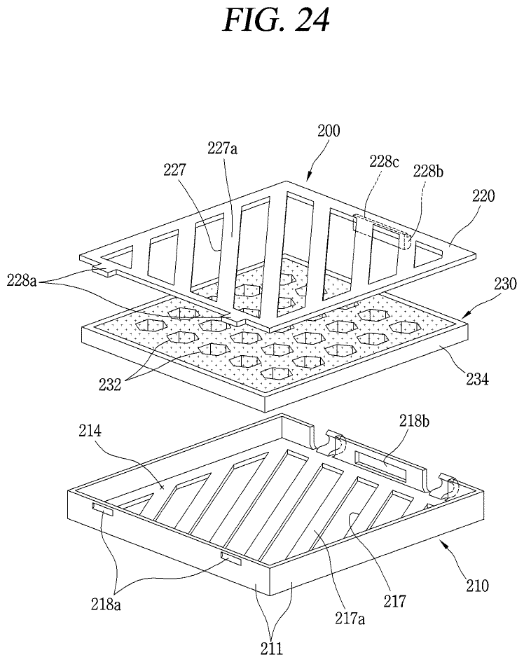

FIG. 21 is a front view of an example in which the filter module 100 crosses the shelf 16 and is arranged on the rear side of the shelf 16, and FIG. 22 is a perspective view of FIG. 21. FIG. 23 is a perspective view of an example in which the filter module 100 is arranged on the rear side of the shelf 16 to cross the shelf 16. FIG. 24 is an exploded perspective view of the filter module 100 of FIG. 23.

In some embodiments, the filter module 100 may be arranged parallel to the shelf 16 or may be arranged in a direction crossing the shelf 16.

In this embodiment, the filter module 100 may be arranged on a side surface of the inside of the refrigerator and allow cold air flowing along a side direction in the refrigerator to pass therethrough, thereby improving a deodorizing effect.

This embodiment has an advantage in terms of convenience of replacement because the coupling member 119 is arranged on the coupling housing 110 to be simply and detachably coupled to the shaft 16c. By excluding the slots from the coupling housing 110, a simpler structure can be achieved.

Hereinafter, another embodiment in which the filter module 100 is arranged on the rear side of the shelf 16 will be described with reference to FIGS. 21 to 24.

A refrigerator 1 according to the disclosure includes a cabinet having a storage space with one side open, a door 14 installed on the cabinet to open and close the storage space, a shelf 16 installed on the inside of the cabinet in the storage space, a shaft 16c installed on the shelf 16, and a filter module 200 having a filter member 130 installed in an accommodation space 124, and the filter module 200 is installed to be detachable by including a coupling member 219 formed as a curved member to surround a portion of the shaft 16c.

The shaft 16c may be arranged on the rear of the shelf 16 to be positioned near the rear wall of the case 11. The coupling member 219 may be arranged as two coupling members spaced apart from each other, and coupled to one shaft 16c.

The filter module 200 includes an accommodating housing 210, a filter member 230, and a cover housing 220.

The accommodating housing 210 may have an accommodation space 214 in which the filter member 230 is accommodated.

The accommodation space 124 of the accommodating housing 210 may be defined by side walls provided at the edges of the accommodating housing 210.

The accommodating housing 210 may also include the coupling member 219. The coupling member 219 of the accommodating housing 210 is similar in structure to the coupling member 119 described in the previous embodiment, but differs in that it is coupled to only one shaft 16c.

The coupling member 219 may be a curved member which protrudes from one side of the accommodating housing 210 to surround a portion of the shaft 16c, and is detachably coupled to the shaft 16c.

The coupling member 219 may be arranged in a direction that the filter module 200 crosses the shelf 16.

The coupling member 219 may be elastically deformable so as not to break when coupled to or uncoupled from the shaft 16c.

The filter module 200 may be arranged parallel to the rear wall of the case 11 near the rear wall of the case 11.

The coupling member 219 may be arranged as two coupling members. The two coupling members 219 may be arranged to be spaced apart from each other. Unlike the previous embodiment, the two coupling members 219 are coupled to one shaft 16c.

For example, in this embodiment, unlike the previous embodiments, the two coupling members 219 are arranged parallel to one shaft 16c.

As described above, the case 11 may include a cold air discharge port 11c which supplies cold air to the storage space.

The filter module 200 may be arranged to at least partially overlap the cold air discharge port 11c.

Cold air which has passed through the cold air discharge port 11c may be brought into direct contact with the filter module 200, thereby further improving the deodorizing effect.

This can help the user avoid unpleasant odors.

The filter member 230 is installed in the accommodation space 124.

Cold air which has passed through the filter member 230 has its odors removed.

For example, the filter member 230 may include zeolite, silica, carbon fiber, and activated carbon. The filter member 230 may include a structure having a plurality of holes, a porous material, and a mesh structure.

For this reason, the filter member 230 preferably has a wide cross-sectional area in contact with cold air when the cold air containing odors passes therethrough, to maximize a deodorizing effect.

For example, the filter member 230 may be a flat plate having a predetermined thickness. This structure of the filter member 230 is advantageous of collecting odor substances from cold air containing odors while the cold air passes through the filter member 130, and minimizing the flow resistance of the cold air, thereby suppressing the deterioration of refrigeration performance.

The filter member 230 may also have, for example, a rectangular shape.

As shown in FIG. 24, an example of the filter member 230 with a roughly square shape is shown, but the shape of the filter member 230 is not necessarily limited thereto.

A plurality of flow holes 232 may be formed to be spaced apart from one another, and may each be formed in a polygonal shape so as to maximize a contact cross-sectional area when cold air flows.

As shown in FIG. 24, an example is shown in which the filter member 230 includes the plurality of flow holes 232 each formed in a hexagonal shape and spaced apart in up-down and left-right directions.

The filter member 230 may include a substance with a specific scent. For example, the filter member 230 may include a substance emitting an aroma. This allows the user to experience a more pleasant sense of smell in addition to simply eliminating odors.

The filter member 230 may include a side protection portion 234 which is installed in the accommodating housing 210 while protecting side portions of the filter member 230.

The side protection portion 234 may be installed to surround the side portions of the filter member 230.

The side protection portion 234 is preferably formed in a shape that matches the side portions of the filter member 230.

By the side protection portion 234, the filter member 230 can be stably accommodated in the accommodating housing 210 while the side portions of the filter member 230 are protected.

The accommodating housing 210 and the cover housing 220 may each include cold air passage holes 217 ad 227 through which cold air can flow.

Of the accommodating housing 210 and the cover housing 220, the cold air passage hole 217 of the accommodating housing 210 adjacent to the cold air discharge port 11c may be arranged on an inlet side, and the opposite cold air passage holes 227 of the cover housing 230 may be arranged on an outlet side.

Accordingly, cold air which flows in through the cold air discharge port 11c may be introduced into the accommodation space 214 through the cold air passage holes 217 on the inlet side, and then flow toward the inside of the refrigerator from the accommodation space 214 through the cold air passage holes 227 on the outlet side.

The cold air passage holes 217 and 227 may each be arranged as a plurality of cold air passage holes spaced apart from one another.

The cold air passage holes 217 and 227 may each be formed in a polygonal shape, and as shown in FIG. 24, may each be formed in an approximately trapezoidal shape.

The cold air passage holes 217 and 227 may be arranged continuously in the accommodating housing 210 and the cover housing 220.

The cold air passage holes 217 and 227 are preferably formed in as many areas as possible to improve the flow performance of cold air passing through the accommodating housing 210 and the cover housing 220.

In the disclosure, an example is shown in which the cold air passage holes 217 and 227 are formed in approximately half or more of each of the accommodating housing 210 and the cover housing 220.

The cold air passage holes 217 and 227 are formed in the accommodating housing 210 and the cover housing 220 to improve cold air flow performance while maintaining a certain rigidity.

For this purpose, for example, the accommodating housing 210 and the cover housing 220 may each include partition ribs 217a and 227a.

The partition ribs 217a and 227a may extend in a diagonal direction of the accommodating housing 110 and the cover housing 230. The partition ribs 217a and 227a may each be arranged as a plurality of partition ribs extending in a spacing manner.

The partition ribs 217a and 227a may have approximately the same structure with a predetermined width, and may be arranged continuously to form the cold air passage holes 217 and 227.

The partition ribs 217a and 227a may form the cold air passage holes 217 and 227 each having a polygonal structure.

The partition ribs 217a and 227a may form the cold air passage holes 217 and 227 while supporting the filter member 230 not to be separated.

Hereinafter, the structure in which the accommodating housing 210 and the cover housing 220 are coupled will be described.

The cover housing 220 may include a first coupling protrusion 228a and a second coupling protrusion 228b.

The first coupling protrusion 228a may protrude from one side of the cover housing 220.

The first coupling protrusion 228a may be arranged as a plurality of first coupling protrusions spaced apart from each other.

The first coupling protrusion 228a may have a predetermined length.

The second coupling protrusion 228b may protrude from the other side of the cover housing 220.

The cover housing 220 may further include a coupling support portion 228c extending from the other side of the cover housing 220 in a direction crossing the body of the accommodating housing 210. The coupling support portion 228c may be configured to come into contact with the cover housing 220, to stably support the accommodating housing 210 when the accommodating housing 210 and the cover housing 220 are coupled.

For example, a second coupling protrusion 228b may protrude from the coupling support portion 228c in an opposite direction to the protruding direction of the first coupling protrusion 228a.

FIG. 24 shows that, based on the direction in which the filter module 200 is coupled to the shelf 16c of the shelf 16, two first coupling protrusions 228a are arranged spaced apart from each other on a lower side of the cover housing 220, and the coupling support portion 228c is arranged on an upper side of the cover housing 220, and the second coupling protrusion 228b is formed on the opposite surface of the coupling support portion 228c that is invisible in the drawing.

However, it is not necessarily limited to the structure of FIG. 24, and the second coupling protrusion 228b, like the first coupling protrusion 228a, may protrude from the other side of the cover housing 220 without the coupling support portion 228c.

The accommodating housing 210 may include a first coupling hole 218a and a second coupling hole 218b.

The first coupling hole 218a may be formed at one side wall 111 of the accommodating housing 210.

For example, the first coupling hole 218a may be arranged as a plurality of first coupling holes spaced apart from each other.

The first coupling hole 218a may be formed in a long hole shape so that the first coupling protrusion 228a can be inserted.

The second coupling hole 218b may be formed at the other side wall 211 of the accommodating housing 210.

The second coupling hole 218b may be formed in a long hole shape so that the second coupling protrusion 228b can be inserted.

FIG. 24 shows an example in which two first coupling holes 218a are formed in the long hole shape to be spaced apart from each other on a lower wall of the accommodating housing 210 (based on the direction in which the filter module 200 is installed on the shaft 16c). FIG. 24 shows an example in which the second coupling hole 218b having a roughly rectangular shape is formed on an upper wall of the accommodating housing 210 (based on the direction in which the filter module 200 is installed on the shaft 16c).

In this embodiment, the filter module 200 may be arranged on a rear surface of the inside of the refrigerator and allow cold air flowing along a side direction in the refrigerator to pass therethrough, thereby improving the deodorizing effect.

For example, as the filter module 200 is positioned to overlap a portion of the cold air discharge port 11c, the cold air flowing out through the cold air discharge port 11c can come into direct contact with the filter module 200, thereby improving the deodorizing effect, resulting in enabling the user to resolve the discomfort caused by the odors inside the refrigerator.

In this embodiment, the structure in which the accommodating housing 210 and the cover housing 220 are detachably coupled can be provided, so that the filter member 230 can be replaced more easily.

The refrigerator 1 is not limited to the configuration and method of the embodiments described above, but all or some of the embodiments may be selectively combined so that various modifications can be made.

It will be apparent to those skilled in the art that the present disclosure may be embodied in other specific forms without departing from the spirit or essential characteristics thereof. The above detailed description should not be limitedly construed in all aspects and should be considered as illustrative. Therefore, all changes and modifications that fall within the metes and bounds of the claims, or equivalents of such metes and bounds are therefore intended to be embraced by the appended claims.

What is claimed is:

1. A refrigerator comprising:
a case having a storage space with one side open;
a door arranged on the case to open and close the storage space;
a shelf installed inside the case in the storage space;
at least two shafts installed at the shelf to be spaced apart from each other; and
a filter module comprising a filter member and detachably installed on the shafts.

2. The refrigerator of claim 1, wherein the filter module comprises:
a coupling housing detachably installed on the shafts;
a receiving housing installed on the coupling housing and having an accommodation space for accommodating the filter member; and
the filter member installed in the accommodating space.

3. The refrigerator of claim 2, wherein the receiving housing is installed to be slidable relative to the coupling housing.

4. The refrigerator of claim 3, wherein the receiving housing comprises mounting portions formed by bending outward at ends of both side walls forming the accommodation space, and
the coupling housing comprises guide ribs arranged on both side walls thereof to support lower sides of the mounting portions, and connecting the mounting portions to be slidable.

5. The refrigerator of claim 4, wherein the guide ribs are formed by bending inward at ends of the both side walls of the coupling housing.

6. The refrigerator of claim 2, wherein the receiving housing comprises:
a pressing portion arranged on an outside thereof to be pressed by a user; and
a stopping protrusion connected to the pressing portion and protruding from one side opposite to the pressing portion,
the coupling housing comprises a protrusion rib fixed by catching the stopping protrusion in a state where the receiving housing has been inserted.

7. The refrigerator of claim 2, wherein the coupling housing comprises:
a first slot arranged on one side thereof and formed in a first direction to be guided and mounted on one of the at least two shafts; and
a second slot arranged on the other side spaced from the one side, and formed in a second direction crossing the first direction, such that the filter module is secondarily coupled after being primarily mounted in the first slot.

8. The refrigerator of claim 7, wherein the second slot comprises an anti-separation portion protruding from an end portion thereof in the first direction by a predetermined distance to suppress separation of the other shaft.

9. The refrigerator of claim 2, wherein the receiving housing comprises:
side walls supporting the filter member on both sides thereof forming the accommodation space; and
support portions having at least a portion bent or curved to support the filter member on the other side.

10. The refrigerator of claim 1, further comprising:
a tray installed on the shafts to be movable along an extension direction of the shafts,
wherein the filter module is arranged on one side or the other side of the tray.

11. The refrigerator of claim 2, wherein the coupling housing comprises a coupling member protruding from one side thereof to detachably couple the coupling housing while surrounding a portion of the shaft, such that the filter module is arranged in a direction crossing the shelf.

12. The refrigerator of claim 11, wherein the filter module is arranged parallel to an inner wall of the case near the inner wall of the case.

13. The refrigerator of claim 2, wherein the coupling housing comprises a first flow path arranged spaced apart from the shelf by a predetermined distance, such that cold air flows between the coupling housing and the shelf.

14. The refrigerator of claim 2, wherein the coupling housing and receiving housing each comprise a cold air passage hole through which cold air flows wherein the cold air passage hole is arranged as a plurality of cold air passage holes spaced apart from one another.

15. The refrigerator of claim 13, wherein the coupling housing and receiving housing each comprise a cold air passage hole through which cold air flows, and the refrigerator further comprises a second flow path through which cold air is introduced into the accommodation space or discharged from the accommodation space, and a third flow path arranged below the receiving housing and communicating with the second flow path.

16. A refrigerator comprising:
a case having a storage space with one side open;
a door arranged on the case to open and close the storage space;
a shelf installed inside the case in the storage space;
a shaft installed on the shelf; and
a filter module comprising a filter member installed in an accommodation space,
wherein the filter module is installed detachably by comprising a coupling member having a curved shape to surround a portion of the shaft.

17. The refrigerator of claim 16, wherein the case comprises a cold air discharge port through which cold air is supplied to the storage space, and
the filter module is arranged to at least partially overlap the cold air discharge port.

18. The refrigerator of claim 17, wherein the shaft is positioned on a rear of the shelf to be arranged near a rear wall of the case, and
the coupling member is arranged as two coupling members spaced apart from each other, and the two coupling members are coupled to the shaft.

19. The refrigerator of claim 16, wherein the filter module comprises:
an accommodating housing comprising the coupling member and having the accommodation space therein;
a cover housing coupled to the accommodating housing; and
the filter member.

20. The refrigerator of claim 19, wherein the cover housing comprises:
a first coupling protrusion protruding from one side of the cover housing; and
a second coupling protrusion protruding from the other side opposite to the one side, and
wherein the accommodating housing comprises:
a first coupling hole formed in one side wall of the accommodating housing, such that the first coupling protrusion is inserted; and
a second coupling hole formed in the other side wall, such that the second coupling protrusion is inserted.
